(19) United States
(12) Patent Application Publication
(10) Pub. No.: US 2023/0013388 A1
(43) Pub. Date: Jan. 19, 2023

(54) Impulse mover

(71) Applicant: Arthur Benny Harper, Westminster, CA (US)

(72) Inventor: Arthur Benny Harper, Westminster, CA (US)

(21) Appl. No.: 17/300,487

(22) Filed: Jul. 19, 2021

(51) Int. Cl. F03G 3/00

(52) U.S. Cl. CPC F03G 3/087; F03G 3/094

(57) ABSTRACT

A nonpropellant inertial device to propel structures on and off earth is disclosed. Secured on a rigid planar base are electrically powered motors for two crankshafts. Pair of parallel linkages are connected between the crankshafts and the sides of a freely rotatable cylintrical weight. The crankshafts rotate differentially to create straight-line reciprocating motion to the linkages. The linkages are design to only pull the cylindrical weight from one side then the other causing the weight to rotate back and forth in reciprocal motion, traverse to the straight-line motion of the linkages. High frequency impulses alternate from the sides of the cylintrical weight with each impulse being a simultaneous action-reaction event. However, only part of the angular action to the weight, directly opposes the straight-line reaction to the crankshafts. Therefore, a net amount of reaction remains to impart unidirectional inertial propulsion to the mover. Two similar cylintrical weight systems are generally used for cancelling out lateral vibrations to the mover.

### FIELD OF THE INVENTION

This invention relates to inertial propulsion systems and more in particular to nonpropellant, mechanical inertial propulsion systems.

### BACKGROUND OF THE INVENTION

In the past only rockets could travel in space in the absence of an atmosphere. Since the early seventies, mechanical nonpropellant inertial movers have become more popular as a possible alternative to the rocket for various uses. Both rockets and nonpropellant movers are closed inertial propulsion systems, as no external reaction with the environment is used for propulsion. However, rockets contain propellant mass that gets burned away during propulsion, making the rocket useless. Whereas nonpropellant, mechanical inertial movers retain the mass they use for propulsion, to be used over and over again. All nonpropellant inertial movers use at least one freely movable mass, with the intention of creating a greater inertial force in one direction for propulsion. Electricity can power nonpropellant movers, which is a great advantage when used in outer space and on planets with little or no atmosphere. Electricity is a more available and accessible long term energy source than rocket fuel, as well as being environmentally safe and user friendly.

There are different types of nonpropellant inertial movers. Although some maybe successful impart, they all have been nevertheless insufficient for practical use. Linear movers are a common type of inertial mover. Some examples of linear type movers are described in the following patents.

U.S. Pat. No. 3,266,233, Aug. 16, 1966 by A. W. Farrall discloses electrically powered linear mover embodiments. Each with a very large weight that pivots back and forth by pistons and springs for the intended inertial propulsion.

U.S. Pat. No. 3,889,543, Jun. 17, 1975 by Oscar Mast discloses a linear mover that uses magnets and gravity for a weight to move back and forth on a mild incline plane, that is along the same direction as the mover for the intended inertial propulsion.

U.S. Pat. No. 4,674,583, Jun. 23, 1987 by Alvin C. Peppiatt is another example of a linear mover. Rotating forces are applied to a crankshaft mechanism powered by an electric motor. The crankshaft moves a weight back and forth along a straight-line track for the intended inertial propulsion.

These linear patents appear only to counterbalance the opposite straight-line back and forth forces on the weight. Such attempts to get inertial propulsion seem inherently insufficient at best. The solution is a weight that moves traverse to the direction of the line of force that is applied to the weight. Hence, for each impulse the opposing angular action on the weight is less than the straight-line reaction to the mover for unidirectional propulsion.

### SUMMARY OF THE INVENTION

In accordance with the present invention, an electrically powered off world nonpropellant inertial mover uses impulses created by a drive assembly to rotate a cylindrical weight in traverse back and forth reciprocal motion to the straight-line motion by the drive assembly. Impulses simultaneously create a greater straight-line reaction to an opposing angular action. Therefore each impulse produces a net amount of reaction thrust for propulsion. Two similar weight systems are used to cancel out lateral vibrations to the mover.

### ASPECTS OF THE INVENTION

Several basic aspects of the present invention include a simple, compact, solid mechanical inertial device that runs on electricity. It is capable of generating powerfully high frequency unidirectional impulses for off world mobility. It can be used for drones, flying shuttles, gravity belts, flying backpacks over surfaces like the moon and mars, maneeuvering spacecraft and satellites in space, as well as inside space habitats.

Another aspect is to provide crankshafts for positive and accurate reciprocal timing to the linkages as they pull the cylindrical weight from side to side.

Another aspect is to provide a drive assembly that includes two crankshafts differentially geared for converting rotary motion into straight-line motion to the linkages.

Another aspect is to provide a cable around the cylindrical weight in which the pulling point on the weight by the cable is always at the intersection where the axis parallel to the plane of rotation of the weight is perpendicular to the line of force to the linkages.

Another aspect is to provide only forward thrust to the mover by each simultaneous action-reaction impulse.

Yet another aspect is to provide two similar weight systems that are synchronized by the drive assembly to cancel out lateral vibrations to the mover.

### BRIEF DESCRIPTION OF THE DRAWINGS

FIG. 1 is a top schematic plan view of the invention.

FIG. 2 is a side schematic plan view of a cylindrical weight.

FIG. 3 is a schematic plan veiw of FIG. 2 with the front half removed.

FIG. 4 is a partial perspective view of connecting rods.

FIG. 5 is a partial perspective view of connecting rods.

FIG. 6 is a partial perspective view of connecting rods.

FIG. 7 is a partial perspective view of connecting rods.

FIG. 8 is a illustrated perspective view of a connecting rod.

FIG. 9 is a rear schematic plan view of the invention.

FIG. 10 is a profile schematic plan view of the invention.

FIG. 11 is a profile schematic view of connecting rods.

### DETAILED DESCRIPTION OF THE INVENTION

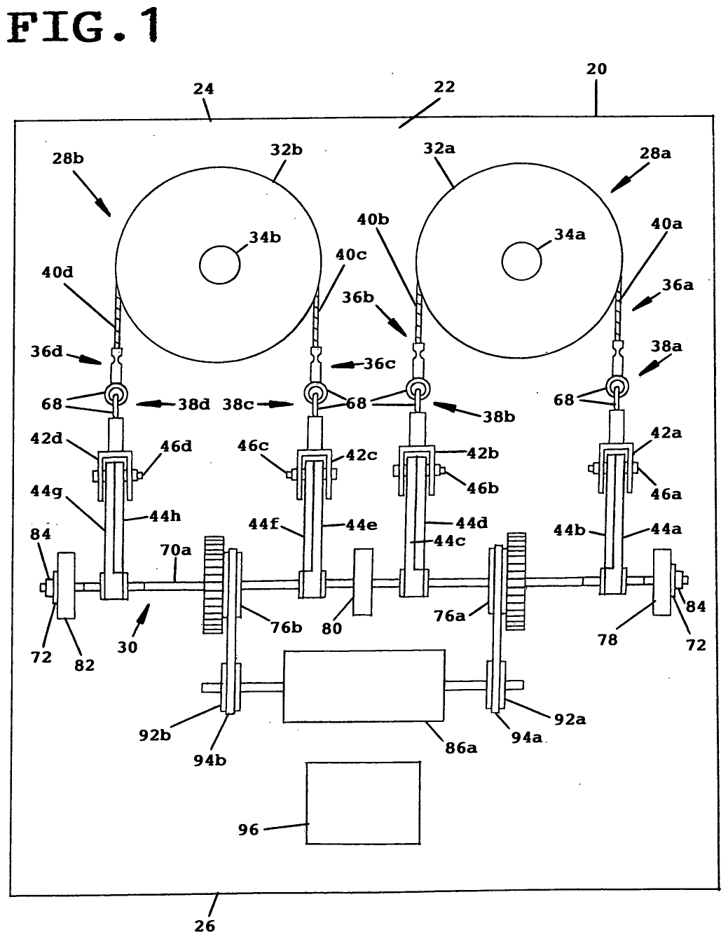

Referring to FIG. 1, an impulse mover 20 used for mobility in space, has a rigid, rectangular planar base 22 of a predetermined: size for accommodating all the elements of mover 20. Planar base 22 is made of high strength aluminum alloy, having a front end 24 and a back end 26.

Two similar weight systems 28a-b are connected laterally along drive assembly 30 and basically include two identical cylindrical weights 32a-b with nut caps 34a-b. Linkages 36a-d extend parallel from the sides of cylindrical weights 32a-b and include identical unidirectional impulse mechanisms 38a-d located between cables 40a-d and union boxes 42a-d. Connecting rods 44a-h are rotatably attached to union boxes 42a-d with pivots 46a-d.

Except for the order of placement of connecting rods 44a-h, weight systems 28a-b are identical. Therefore, for a clearer understanding of the present invention, only weight system 28a will be described in greater detail in the following.

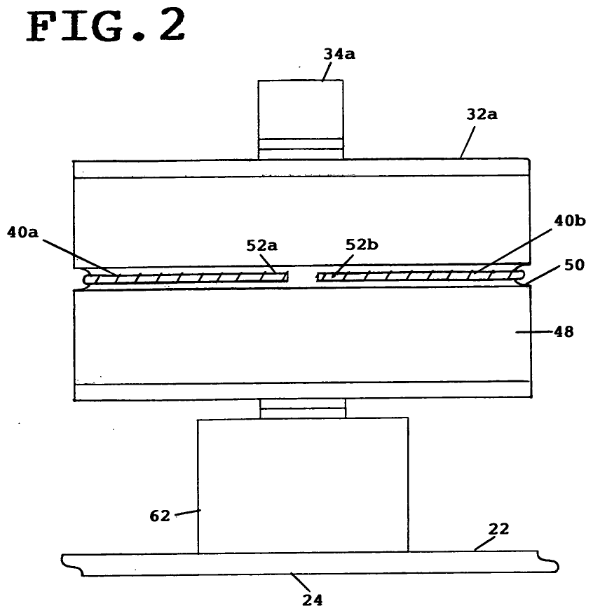

In FIG. 2 cylindrical weight 32a is shown from the side facing front end 24 of base 22. Cables 40a-b are shown wrapped around shell 48 in a middle groove 50 and welded at ends 52a-b. Cylindrical weight 32a is made of strong, high density material such as steel alloy for inertial resistance.

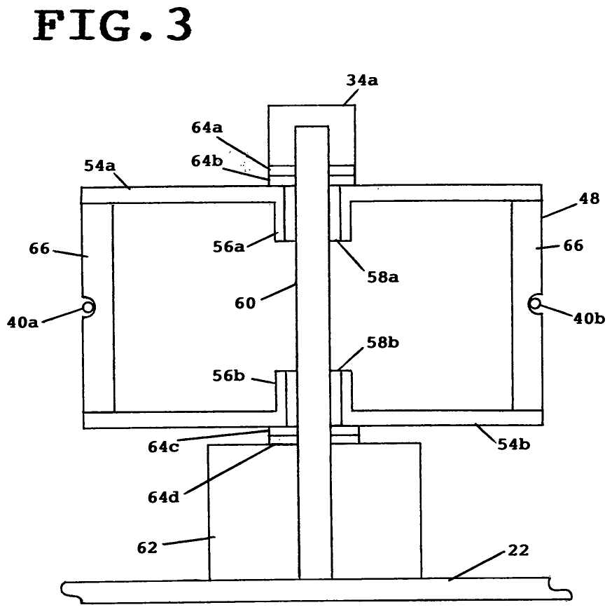

As illustrated in FIG. 3, the front half of cylindrical weight 32a in FIG. 2 has been removed. Shell 48 is shown substantially hollow and covered by lids 54a-b, with centrally located, integrally attached hubs 56a-b. There are two anti-friction journal bearings 58a-b made of soft metal alloy pressure fitted inside hubs 56a-b for smooth rotation of cylindrical weight 32a on axle 60. Axle 60 is made of case harden steel and pressure fitted in aluminum pedestal 62 and secured to base 22. Shell 48 and anti-friction metal washers 64a-d on axle 60 are secured by nut cap 34a. The cylindrical shape of shell 48 allows outermost perimeter 66 to extend for greater inertial resistance .

Referring to FIG. 1, parallel cables 40a-b of linkages 36a-b are made of flexible, high tensile strength inextensible steel and always pull at the same point on perimeter 66 of shell 48. Cables 40a-b are connected to identical ring units 68, made of case harden steel. At the other end, ring units 68 are connected to union boxes 42a-b. Connecting rods 44a-d are rotatably attached to union boxes 42a-b, thus completing the linkages 36a-b.

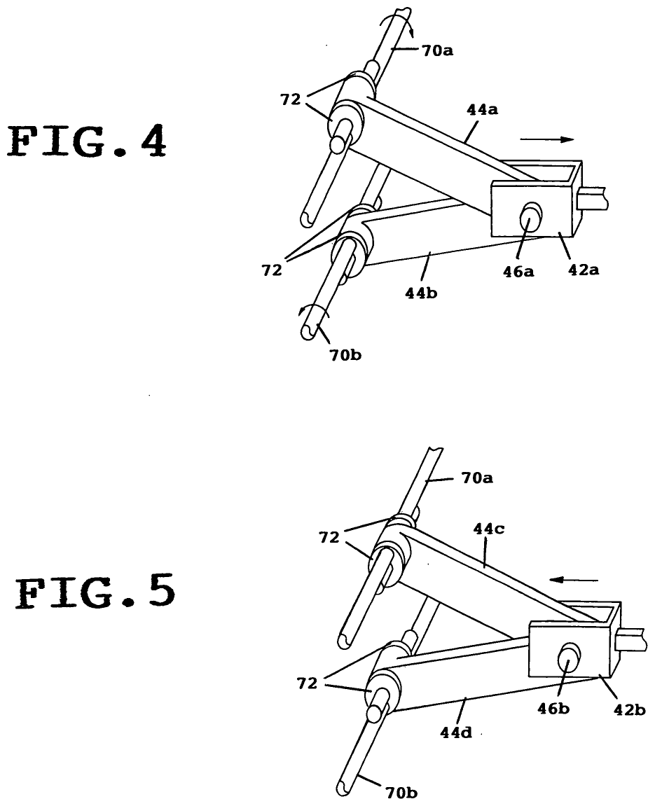

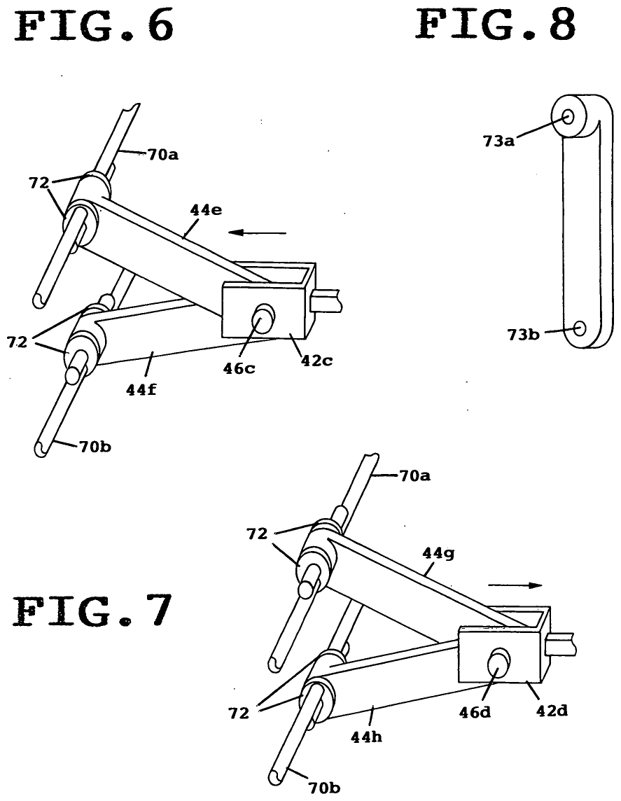

Although identical in shape, all connecting rods 44a-h are arranged along drive assembly 30 in different positions, as shown in the perspective views of FIGS. 4, 5, 6 and 7, which also shows connecting rods 44a-h rotatably attached to crankshafts 70a-b, with identical case harden steel washers 72 on each side. FIG. 8 is an illustrated example of the identical shape of all connecting rods 44a-h in general, with crank bore hole 73a and pivot bore hole 73b.

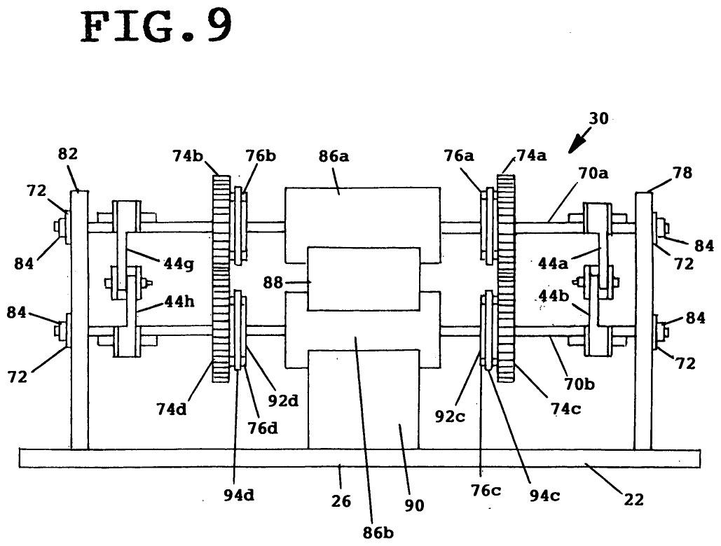

FIG. 9 shows a rear view of drive assembly 30 from back end 26 of base 22. Drive assembly 30 includes two identical parallel crankshafts 70a-b stacked horizontal to base 22. Gear 74a is joined to shaft pulley 76a and gear 74b is joined to shaft pulley 76b and both are fixed on crankshaft 70a. Gear 74c is joined to shaft pulley 76c and gear 74d is joined to shaft pulley 76d and both are fixed to crankshaft 70b. Referring again to FIG. 1, pillars 78, 80 and 82 rotatably support crankshafts 70a-b and are secured by steel washers 72 and identical lock nuts 84 at pillars 78 and 82.

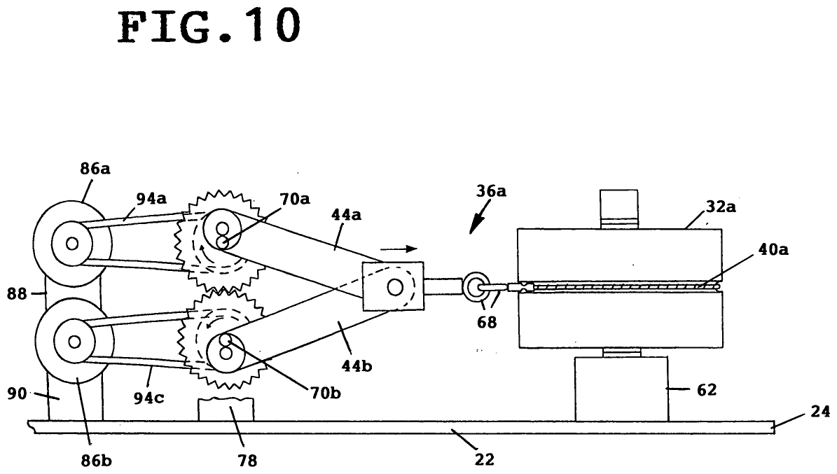

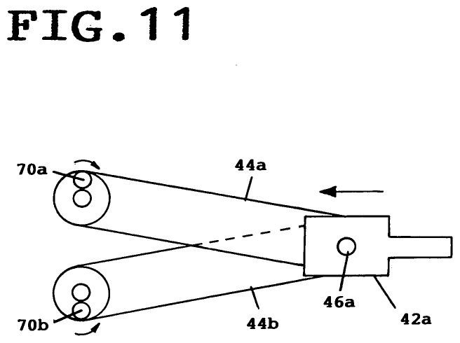

In FIGS. 9 and 10, identical motors 86a-b are secured to base 22 by braces 88 and 90, for imparting rotary motion to drive assembly 30. Best shown in FIG. 1, motor pulleys 92a-b are coupled to shaft pulleys 76a-b of crankshaft 70a by drive belts 94a-b. Motors 86a-b are powered by a conventional storage battery 96. FIG. 9 shows motor pulleys 92c-d coupled to shaft pulleys 76c-d of crankshaft 70b by drive belts 94c-d.

FIG. 10 shows linkage 36a horizontal to base 22 and moving in the direction towards front end 24. Crankshaft 70a is in clockwise rotation and crankshaft 70b is in counterclockwise rotation. FIG. 11 shows a graphic illustrated view of connecting rods 44a-b moving in the direction towards crankshafts 70a-b, as crankshaft 70a is rotating clockwise and crankshaft 70b is rotating counterclockwise.

### Operation

Although similar weight systems 28a-b are concurrently used on mover 20, for a clearing understanding of the operation of the invention, only weight system 28a is described in the following.

In weight system 28a, energy from battery 96 turns motor 86a clockwise and motor 86b counterclockwise, which transfers rotary energy to crankshafts 70a-b. Crankshafts 70a-b then rotate in a differential manner for straight-line motion to linkages 36a-b, which are position parallel to opposite sides of cylindrical weight 32a and parallel to the intended direction of motion of mover 20. Weight 32a is pulled from side to side by alternating impulses in a back and forth reciprocal, traverse motion by the straight-line linkages 36a-b. Heavy perimeter 66 on weight 32a offers greater inertial resistance to being pulled. Crankshafts 70a-b can rotate at thousands of revolutions per minute, to produce high frequency alternating impulses. Linkages 36a-b are permanently set along crankshafts 70a-b at predetermined positions for positive reciprocate timing for linkages 36a-b, as they pull weight 32a from side to side.

Linkages 36a-b always remain taut as they move back and forth, and only pull and never push on the sides of cylindrical weight 32a. So each impulse only creates a forward thrust in the direction of motion of mover 20. If there is even the slightest push, unidirectional impulse mechanisms 38a-b included on each linkage 36a-b will slacken coupled identical ring units 68 to prevent pushing cylindrical weight 32a.

In one reciprocal cycle of operation, an impulse is created when weight 32a is partially rotated by the pull from linkage 36a. The momentum gained by that pull is stopped instantly by linkage 36b on the opposite side of weight 32a, which then creates another impulse. Linkage 36b then pulls weight 32a from that side, creating yet another impulse as it rotates weight 32a back again to linkage 36a on the opposite side. The traverse motion of weight 32a by the straight-line pull of linkages 36a-b, is repeated continuosly in each back and forth reciprocal cycle.

Every impulse is a simultaneous action-reaction event. However, the action in the present invention is not equal to the reaction. The action force on the rotatable cylindrical weight 32a is angular, relative to the straight-line reaction force to linkages 36a-b. Part of the action of each impulse is diverted laterally to the sides of mover 20 and does not oppose the reaction: So, a net amount of straight-line reaction force remains for unidirectional inertial propulsion to mover 20. Both weight systems 28a-b are conjoined to drive assembly 30, as outer linkages 36a-d alternate back and forth with inner linkages 36b-c to cancel out lateral vibrations to mover 20.

Although not described herein, other methods of construction and design may be used in appling the teaching described herein.

I claim:

1. An impulse mover comprising a rigid planar base having a predetermined size for securing various elements on the mover to be used primarily for off world inertial propulsion mobility, having a power source and at least one motor coupled to a drive assembly, at least one freely rotatable weight on said planar base, with similar parallel linkages extending along opposite sides of said weight, said linkages being coupled between said weight and said drive assembly, said drive assembly being in conjunction with said linkages provides an alternating reciprocal impulse means for applying impulses alternately from opposite sides of said weight, each said impulse includes an identical unidirectional impulse mechanism for applying said impulses unidirectionaly to said weight; said impulses bear an angular action means to said weight that opposes the straight-line reaction to said drive assembly, whereupon a means is provided for a net amount of reaction for imparting unidirectional inertial propulsion to said mover.

2. The impulse mover of claim 1 wherein two similar weight systems are generally used in lateral configuration along said drive assembly, for a lateral vibratory cancelling means to cancel out lateral vibrations to said moverₛ

3. The impulse mover of claim 1 wherein said drive assembly includes two identical parallel crankshafts with a positive timing means for said linkages to reciprocally pull said weight from side to side.

4. The impulse mover of claim 1 wherein said drive assembly includes two identical crankshafts stacked parallel on said planar base, so at least one gear fixed on a top crankshaft is meshed to at least one gear fixed on a bottom crankshaft and a straight-line motion means is provided by the rotation of said gears on said crankshafts for straight-line motion of said linkages.

5. The impulse mover of claim 1 wherein said weight being a freely rotatable, hollow cylintrical shape and made of high density material with a heavy perimeter of predetermined thickness for increased inertial resistance and having a rotatable means to be rotatable on an axle vertically fixed to said planar base.

6. The impulse mover of claim 1 wherein each said linkage includes a flexible, inextensible cable that partially surrounds the perimeter on each side of said weight and a pulling point means is provided for pulling said cable at a point where the axis parallel to the plane of rotation of said weight intersects perpendicular to the line of force of said linkage.
